(19) United States
(12) Patent Application Publication
(10) Pub. No.: US 2009/0222866 A1
(43) Pub. Date: Sep. 3, 2009

(54) Devices and/or Methods for Switching Between Program Sources

(76) Inventors: Stefan Jenzowsky, Berlin (DE); Norbert Löblg, Darmstadt (DE); Rudolf Stelzl, Dachau (DE)

Correspondence Address: MICHAEL N. HAYNES, 1341 HUNTERSFIELD CLOSE, KESWICK, VA, 22947, US

(21) Appl. No.: 12/094,001

(22) PCT Filed: Sep. 6, 2007
(86) PCT No.: PCT/EP2007/059334

§ 371 Date: Aug. 27, 2008

(30) Foreign Application Priority Data
Sep. 18, 2006 (DE) 102006043701.2

(51) Int. Cl. H04N 7/173

(52) U.S. Cl. 725/93; 725/100

(57) ABSTRACT

Certain exemplary embodiments can provide a method comprising: determining a second program corresponding to a received first program; recognizing an interruption of the first program; based on a time of the interruption, specifying a time of continuation of the second program; and transmitting the second program to an output unit at the time of continuation.

Radio and television programs reach their audience over a large number of transmission paths. Apart from terrestrial reception, the distribution of the radio and television programs over landline and mobile radio networks is increasingly gaining importance. For example, a large number of the programs can also be called up by a video on demand service. To find program contributions and for planning times for remaining in front of a multimedia device, program information and EPG Electronic Program Guide data are offered to the multimedia subscriber.

The invention is based on the object of specifying a device and an associated method for individually switching between broadcast and unicast programs.

The solution of the object is obtained from the features of patent claims 1 or 6.

The invention entails the advantage that a transition from a broadcast program to an identical program which can be sent out, e.g. in unicast mode, can be carried out.

The invention entails the advantage that a transition from a program contribution radiated by broadcasting to a program contribution of the same content, which can be sent out in unicast mode and is uninterrupted can be rapidly made possible and thus a current and/or future interruption can be bypassed.

The invention entails the further advantage that during a transition from a broadcast program to a unicast program of the same content, there is no failure or no repetitions of program sections.

Further particularities of the invention will become apparent from the subsequent, more detailed explanations of exemplary embodiments, with reference to drawings, in which:

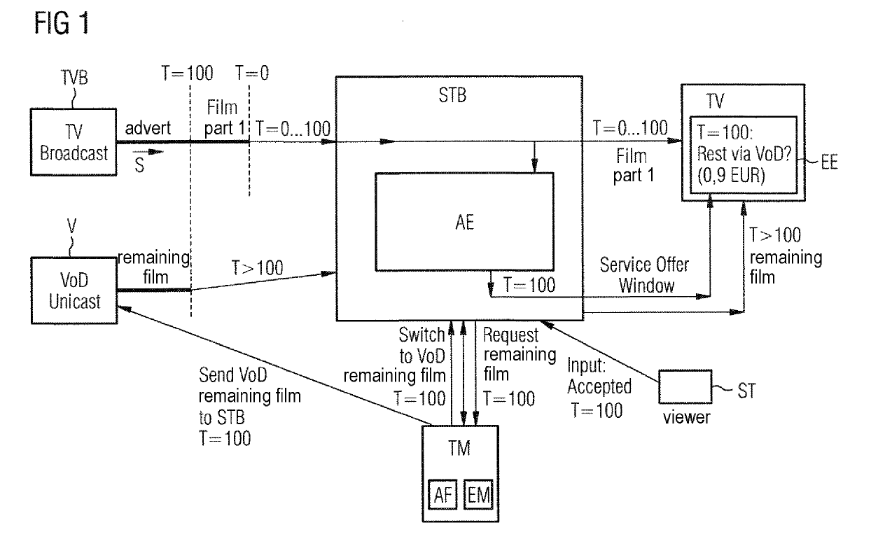

FIG. 1 shows a block diagram for a reception of

programs,

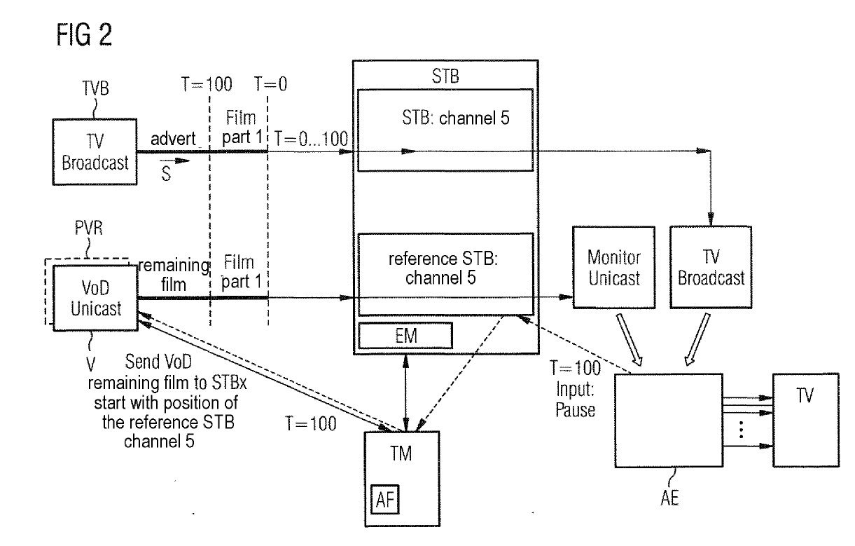

FIG. 2 shows a further block diagram and

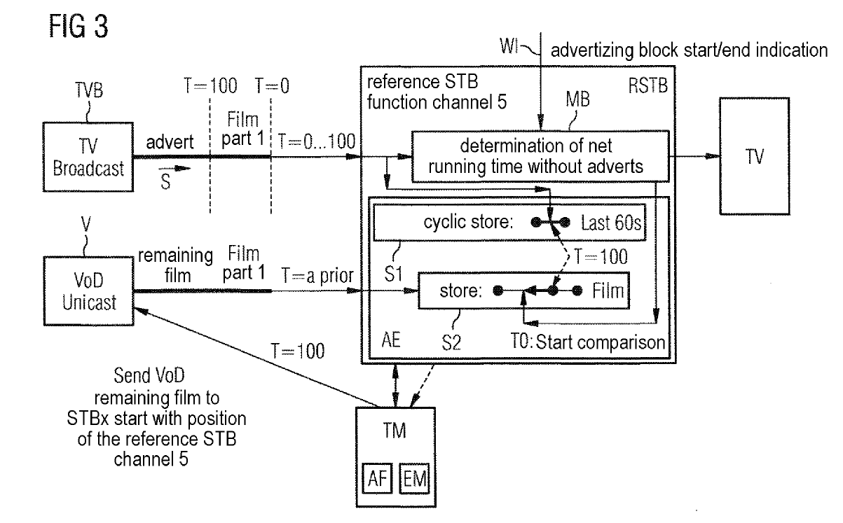

FIG. 3 shows a further embodiment.

FIG. 1 shows diagrammatically a block diagram for a reception of programs by broadcasting and/or unicasting. Starting from a broadcast station TVB, particularly a TV broadcast station, programs or program contributions are distributed to possible receiver units. The distribution function can also be supported by facilities subordinate to the broadcast station TVB such as, e.g. TV head ends and routers for converting the TV broadcast signal into the respective transport technology or for forwarding the TV broadcast signal in this transport technology, e.g. according to the Internet protocol, which is not shown in FIG. 1 for reasons of simplicity. In this example, the program signal S is received by a receiver unit such as, for example, a set top box STB and forwarded to a display unit TV connected to it. In the set top box STB, an analysis unit AE for recognizing content interruptions, for example caused by advertizing blocks, is integrated in a receiver unit. In a management unit TM connected to the set top box, a determining unit EM and a requesting unit AF is arranged. The determining unit EM is here arranged in such a manner that further programs which are similar or identical to those which can be currently received by multimedia subscribers, for example by broadcast, can be determined. This determining unit EM can also be arranged centrally, e.g. at a provider. The further programs selected by the determining unit EM are received by unicast. The programs which can be received by broadcast can also be called first programs and the programs which can be received, for example by unicast, can also be called second programs. The second programs are preferably free of additional program contributions such as, e.g. advertizing spots. The requesting unit AF can be used for handling delivery conditions between the multimedia subscriber and a provider of a second program. A delivery and/or reception of current or recorded programs from a TV community is possible. The management unit TM shown is connected to at least one provider.

The analysis unit AE provides, for example, for recognition of an advertizing block by a concurrent processor-controlled evaluation of the program content. An advertizing block could be recognized, for example, by omission of a logo, inserted into a program transmission, from a program station radiating this program.

In the management unit TM or in the determining unit EM, electronic program guide data, which are either received via a received broadcast channel, from a provider or via an interface, not specified in greater detail here, at the set top box, are temporarily stored and evaluated for determining second programs. These electronic program guide data can be program times, length of the program, an international film identification and additional information of films, programs or contributions. In addition, data records of films or contributions, which can be called up via unicast, of information about program duration, author and brief descriptions are evaluated.

After the provision of the electronic program guide data of a receivable broadcast program and/or with the sending out of a receivable broadcast program, a concurrent comparison is made in the determining unit EM between the available data records, taking into consideration probabilities of attaining a reliable selection of, e.g. identical programs without advertizing sequences from a second source.

Generally, freedom from advertizing blocks of a second program can already be inferred from the type of the second source. If required, the selected second programs are indicated to the multimedia subscriber in a window. The data comparison addressed can run permanently in the background of the determining unit EM.

In the run-up to a selective reception of a program from a further provider, a second program of identical or corresponding and generally approximately equal content as a first program is selected, as listed above, by means of a comparison of provided second programs by means of a multiplicity of comparison criteria such as title, playing time, production date, members of the cast and other features of origin and indicated to the viewer or listener as uninterrupted second program via signaling fields of the multimedia device. In this connection, other versions of programs such as, for example, abbreviated versions, unshortened productions of second programs, further second programs, supplementary or similar programs with different cast, direction or playing time can also be offered to the viewer. For this purpose, an offer for purchasing an uninterrupted second program or an uninterrupted film from another provider is indicated, for example, to the viewer.

If the multimedia subscriber accepts possible purchasing and/or licensing conditions, transmission and reception procedures are run by the requesting unit AF or the management unit TW and the output of the program is started. As indicated in FIG. 1, this switching from broadcast mode to unicast mode is initiated at T=100. In the first program broadcast up to this time, the transmission of an advertizing block, for example, is begun at time T=100. The analysis unit AE arranged, for example, in the set top box recognizes the switch to an advertizing contribution, made in the first program, and opens a window with a possible listing of the similar/identical second programs or identical program contributions without interruption, determined by the determining unit EM, on a display or screen. After request of a second program by the viewer or listener and in the event of agreement to a possible charge being made or a licensing condition, the arrangement shown switches to the second program, which can be called up at a provider, e.g. by a unicasting, at time T>100.

When the viewer or listener agrees to provider-dependent program conditions and especially to the costs possibly arising, the remaining film is requested via a request by the management unit TM. The management unit TM or the requesting unit AF handles the necessary signaling procedures between provider and set top box, e.g. before the beginning of the transmission of the remaining film. In the set top box, reception is switched to the second program, which can be received by unicast mode, or the remaining film which can be received by means of unicast mode. The second program transmitted by means of unicast is forwarded to the multimedia device TV instead of the film which can be received by broadcasting.

FIG. 2 shows a further embodiment of a device and the associated method for switching between a program which can be received by broadcasting and unicasting. In this arrangement, a multiplicity of multimedia subscribers can be supplied. For example, the broadcast signal of a first program is here compared under processor control with an identical second program which can be received from a further provider, for example in an evaluating unit AE, and synchronization procedures are initiated. This synchronization can take place centrally or locally if the computer power and transmission bandwidths necessary for this exist at at least one multimedia subscriber. As described above, a preselection of a program of the same content or of a program similar to the original program is carried out.

In the case of local processing, the monitoring reference set top box indicated in FIG. 2 is arranged at the abovementioned multimedia subscriber. In the case of central synchronization, the identical program offered by a third party would be synchronized with an associated broadcast program and, after individual request, for example at the beginning of an advertizing contribution, in each case conducted preferably directly from the unicast source V to the requesting multimedia subscriber by means of unicast mode instead of the broadcast film, after acceptance of the program conditions of the provider by the receiver or the group of receivers.

The film contribution which can be received from a provider or a TV or Internet community by unicast can be synchronized with the reference set top box system to the program which can be received by broadcast, similarly under processor control by pause/restart, forward and reverse. Among other things, requests for sending out the uninterrupted remaining video will be received by the management unit TM.

With this arrangement, the further output of the remaining video to any other set top box actively connected to the management unit TM can take place at the place at which the reference system selects an advertizing block. A switch-over can take place centrally or, e.g. by operation of a defined function key of a remote control or after explicit input of an agreement declaration or of a proof of authorization (PIN, password) by the multimedia subscriber. If the requesting unit AF cannot directly activate a video on demand output, the video on demand output can be made available instead as a copy of a personal video recording PVR function. The remaining video is started on request of one or more viewers with reference to the stop position of the personal video recorder system or of the reference system via the management unit TM.

The determining unit EM shown in FIG. 2 in the reference STB can also be a part of the management function TM.

FIG. 3 shows a further embodiment of a structure of a device and associated method steps for automatically switching from a broadcast program to a unicast program of identical or almost identical content. The set top box, which can also be called reference set top box RSTB, is here arranged in such a manner that a module MB determines the net running time of a first program radiated by broadcasting. Furthermore, an evaluating unit AE is provided with a first and second storage unit S1, S2. The first storage unit S1 is arranged in such a manner that it temporarily stores, for example, in each case the last 60 seconds of the broadcast program radiated at the time. An identical preselected contribution of the second unicast source as described under FIG. 1 or 2 is temporarily stored in the local second storage unit S2 of the set top box STB. For example, the reference set top box function additionally has access to an external advertizing block beginning and advertizing block end indication. This makes it possible to determine the net program content of the broadcast program hitherto shown. The external advertizing block indication provides an indication about the point at which the contribution obtainable by unicast has to be continued. With the available audio and video information, e.g. the beginning of the advertizing block and the sections of the identical contribution temporarily stored in the stores S1, S2, an accurate time of continuation can be specified under microprocessor control. The time of continuation found is reported to the management unit TM. After the multimedia subscriber has agreed to the delivery conditions of the provider, a switch-over to the unicast reception occurs.

If the beginning of an advertizing block is recognized or signaled, the set top box, e.g., initiates the output of a window on the screen. In this window, the television viewer is alerted to the fact that the first program can be replaced by a second uninterrupted program, see also the descriptions to units EM, AE and AF.

If the television viewer accepts the offer and handles the required inputs with regard to identification or payment conditions such as, e.g. PIN/password/account No., the management unit TM activates the output of the 2nd unicast source.

The simplest criterion for the continuation of the second unicast source at a desired point can be the current time which is related to the announced time of beginning of the TV broadcast source. If the sending out of a film/program contribution has begun at the announced time and if the film/program contribution is identical with the 2nd unicast source or almost identical with the film/program contribution distributed by broadcasting, the film/program contribution can be immediately continued by the film/program contribution which can be received via the second unicast source when the first advertizing block insert is available. In the case of a multiplicity of advertizing inserts and/or if the beginning of transmission of the film/program contribution has been shifted, the embodiments shown in FIGS. 1 to 3 and described in each case individually lead to the selective switching between broadcast and unicast programs of identical or corresponding content.

A central reference set top box allocated to a television channel, e.g. channel 5, as shown in FIG. 2, determines the actual start of the contribution with 2nd unicast source and the sum of the advertizing blocks accrued in this contribution and already ended.

Determining the time of continuation in a 2nd unicast source is a unique process with regard to program channel, contribution and respective advertizing pause. The time of continuation can be determined centrally or decentralized.

The process of searching for possible identical program contributions or program contributions with identical content or subject before a first request of a program contribution from the 2nd unicast source can also be initiated by the television viewer.

The reference set top box system can also consist of two set top boxes, wherein the TV broadcast program radiated is in each case compared concurrently under processor control with a 2nd unicast source and specifies a switchover time by means of pause, forward and reverse function the 2nd unicast source, particularly at the beginning of an advertizing pause, see also FIG. 2 in this regard. If the immediate continuation of the program contribution from the 2nd unicast source is requested progressively by the television viewers, the second source is output from the time of switch-over.

If the point of continuation in the 2nd unicast source is determined as previously described, the individual TV viewer or a multiplicity of TV viewers connected to the reference system, which accept the program conditions in the case of the presence of an advertizing pause, is individually switched to the same time of continuation in the 2nd unicast source. The offer is extinguished in the simplest case when the end of the respective advertizing pause is reached. In the case of a concurrent comparison between a TV broadcast contribution and its 2nd unicast source, a switch-over is also possible outside advertizing pauses.

The method can be applied just as well to audio programs or music programs which are interrupted by word contributions. In this case, the offer is preferably output via a display of the terminal. Dialogue inputs of the listener can be made directly via the display of a terminal or via key functions in the case of control units.

A processor-controlled reference set top box can be implemented on the computer platform of the management unit TM, on the hardware of the TV head end system, which is responsible for feeding the TV broadcast program into the distribution network, on the hardware of the video on demand system which is responsible for the provision of the video on demand contributions in the unicast mode, or on a separate hardware.

To continue the contribution from the 2nd unicast source, the set top box can also receive the 2nd unicast source via terrestrial reception or satellite reception, if necessary.

The functions of the aforementioned receiver unit (STB) and of the output unit (TV) can also be combined in a single combined receiver and output unit. Such a combined receiver and output unit can be, for example, a mobile telephone with suitable display and SW/FW functionality or a PC with suitable interface cards and suitable SW.

1. A device comprising
a receiver unit adapted to receive a program;
a determining unit communicatively coupled to the received unit and adapted to determine a second program corresponding to the first program;
an analysis unit communicatively coupled to the determining unit and adapted to:
recognize an event interrupting the first program based on a time of the interruption;
determine a time of continuation for the second program; and
transmit the second program to an output unit starting at the time of continuation.

2. The device as claimed in claim 1, further comprising:
a requesting unit communicatively coupled to the receiver unit and adapted to run procedures for handling delivery conditions between a provider providing the second program from the time of continuation and a multimedia subscriber requesting the second program from the time of continuation.

3. The device as claimed in claim 1, wherein:
the determining unit is adapted to the second program corresponding to the first program on the basis of available identification data, selected from production date, playing time, casting, title and international program identification.

4. The device as claimed in claim 1, further comprising:
a management unit adapted to drive the output device in such that a window is formed on the output device, the window adapted to indicate available second programs from which the second program can be selected.

5. The device as claimed in claim 1, further comprising:
a management unit adapted to release second program at the time of continuation, according to a predetermined condition.

6. A method comprising:
determining a second program corresponding to a received first program;
recognizing an interruption of the first program;
based on a time of the interruption, specifying a time of continuation of the second program; and
transmitting the second program to an output unit at the time of continuation.

7. The method as claimed in claim 6, further comprising:
handling delivery conditions between a provider providing the second program from the time of continuation and a multimedia subscriber requesting the second program from the time of continuation.

8. The method as claimed in claim 6, further comprising:
determining the second program corresponding to the first program on the basis of available identification data, allocated to the first and second programs, selected from production date, playing time, casting, title, and an international program identification.

9. The method as claimed in claim 6, further comprising:
forming a window on an output device, the window indicating available second programs from which the second program can be selected.

10. The method as claimed in claim 6, further comprising:
releasing the second program at the time of continuation, according to a predetermined condition.
